(19) United States
(12) Patent Application Publication
(10) Pub. No.: US 2026/0344550 A1
(43) Pub. Date: Nov. 5, 2026

(54) Agricultural Implement for Working Soil and Method of Operating Agricultural Implement

(71) Applicant: Väderstad Holding AB, Väderstad (SE)

(72) Inventors: Emil Muhrman, Åtvidaberg (SE); Erik Wågbrant, Skänninge (SE)

(21) Appl. No.: 19/120,339

(22) PCT Filed: Oct. 11, 2023
(86) PCT No.: PCT/EP2023/078169

§ 371 Date: Apr. 11, 2025

(30) Foreign Application Priority Data
Oct. 12, 2022 (SE) 2251194-3

(51) Int. Cl. A01B 49/02; A01B 63/00; A01B 63/22; A01B 63/32

(52) U.S. Cl. CPC A01B 49/027; A01B 49/02; A01B 63/008; A01B 63/22; A01B 63/32

(57) ABSTRACT

An agricultural implement for working soil, comprises a main frame section (10a, 10b), carrying a plurality of soil working tools (20), a ground support frame (30a, 30b), carrying at least one rolling ground support (31a, 32a; 31b, 32b), a leveler frame (40a, 40b), carrying at least one levelling tool (41), configured for levelling soil that has been worked by the soil working tools (20), and a setting device (50) for setting a distance between the ground support frame (30a, 30b) and the leveler frame (40a, 40b). The ground support frame (30a, 30b) is pivotably connected to the main frame (10a, 10b) by a ground support frame joint (33). The leveler frame (40a, 40b) is pivotable relative to the main frame by a first leveler frame joint (42). The setting device (50) is pivotably connected to the leveler frame (40a, 40b) by a first setting device joint (51), and by a second setting device joint (52) is displaceably connected relative to the ground support frame (30a, 30b), such that the second setting device joint (52) is displaceable relative to the ground support frame (30a, 30b) in a plane that is perpendicular to a pivot axis of the second setting device joint. There is also disclosed a method of operating an agricultural implement.

### TECHNICAL FIELD

The present disclosure relates to an agricultural implement for working soil, i.e. tillage, such as a harrow or a cultivator, having an improved levelling function, and to a method of operating an agricultural implement.

### BACKGROUND

Agricultural implements for working soil are known in the form of harrows and cultivators having a plurality of soil working tools in the form of harrow tines or cultivator tines, respectively, which are carried by a main frame of the agricultural implement.

It is further known to provide such agricultural implements with a gauge mechanism for controlling working depth of the soil working tools by wholly or partially supporting the agricultural implement by means of one or more wheels or rollers. To this end, the gauge mechanism may comprise a ground support frame, which is pivotably connected to the main frame and with a relative position between the main frame and the ground support frame being adjustable by means of an actuator, such as a hydraulic actuator.

It is further known to provide one or more levelling tools configured to level soil which has been worked by the soil working tools. Such levelling tools may be arranged between the soil working tools and a roller, as seen in an operating direction of the agricultural implement.

There is a need for improved agricultural implements for working soil. In particular, it is desirable to be able to optimize the relative vertical positions of the levelling tools and the soil working tools.

### SUMMARY

It is an object of the present disclosure to provide an improved agricultural implement for working soil, and in particular an agricultural implement which provides improved relative vertical positioning of levelling tools and soil working tools.

The invention is defined by the appended independent claims, with embodiments being set forth in the appended dependent claims, in the following description and in the attached drawings.

According to a first aspect, there is provided an agricultural implement for working soil, comprising a main frame section, carrying a plurality of soil working tools, a ground support frame, carrying at least one rolling ground support, a leveler frame, carrying at least one levelling tool, configured for levelling soil that has been worked by the soil working tools, and a setting device for setting a distance between the ground support frame and the leveler frame. The ground support frame is pivotably connected to the main frame by a ground support frame joint. The leveler frame is pivotable relative to the main frame by a first leveler frame joint. The setting device is pivotably connected to the leveler frame by a first setting device joint, and by a second setting device joint is displaceably connected relative to the ground support frame. Hence, the second setting device joint is displaceable relative to the ground support frame in a plane that is perpendicular to a pivot axis of the second setting device joint.

The agricultural implement for working soil may in particular be an implement which is solely dedicated for working soil, i.e. for tillage, such as a cultivator or a harrow, although such an implement may also be provided with an auxiliary seeder, such as for small seed crops or cover crops.

The agricultural implement may comprise one or more main frame sections. In some embodiments, there may be a single main frame section, while in other embodiments there may, as non-limiting examples, be two, three, four or five main laterally aligned frame sections, which may be pivotably arranged relative to each other such that the agricultural implement may be folded between a transport state and an operating state.

In the present context, a “joint” may include one or more bearing arrangements having a common axis of rotation. The bearing arrangements may be mutually separated along said axis of rotation. Each bearing arrangement may e.g. be a roller bearing or a glide bearing.

The agricultural implement may comprise one or more ground support frames. In some embodiments, the number of ground support frames may be the same as the number of main frame sections. In other embodiments, one or more main frame sections may have two or more ground support frames.

The agricultural implement may comprise one or more leveler frames. In some embodiments, the number of leveler frames may be the same as the number of main frame sections. In other embodiments, one or more main frame sections may have two or more leveler frames. In particular, the number of leveler frames may match the number of ground support frames.

The displacement of the second setting device joint provides for an improved movement pattern of the leveler frame relative to the ground support frame in that the relative vertical distance between the levelling tools and the ground support may be reduced as the agricultural implement is set to a shallower working depth of the soil working tools. Similarly, the relative vertical distance between the levelling tools and the ground support can be caused to increase as the working depth of the soil working tools increases.

This is in contrast to a corresponding arrangement wherein the second setting device joint would be fixed relative to the ground support frame, which would cause the vertical distance between the ground support and the levelling tools to diminish as the working depth of the soil working tools increases.

Hence, the levelling tools will be more effective when the soil working tools operate at a shallow depth while maintaining the effectiveness of the levelling tools when the soil working tools operate at a deeper depth.

The levelling tools will better handle the larger soil ridges that are created when the soil working tools operate at a greater depth. This is because at greater working depth of the soil working tools, the levelling tools may be raised, such that they operate at higher portions of the ridges, rather than become buried into the ridges and/or essentially just push the soil forward.

The agricultural implement may further comprise a triangle link, pivotably connected to the ground support frame by a triangle link joint, and a control link, pivotably connected to the main frame by a first control link joint and pivotably connected to the triangle link by a second control link joint. The setting device may be pivotably connected to triangle link by the second setting device joint, such that pivoting of the ground support frame relative to the main frame causes the control link to bring the triangle link to pivot relative to the ground support frame, whereby the second setting device joint is displaced relative to the ground support frame.

A triangle link is defined as a link having at least three pivot joints, with parallel pivot axes, which are positioned at corners of a triangle, as seen in a plane perpendicular to the pivot axes.

The first setting device joint, the first control link joint, the second control link joint and the triangle link joint may be configured such that rotation of the ground support frame in a first direction about the ground support frame joint causes the triangle link to rotate in a second direction, opposite the first direction, about the triangle link joint.

The first leveler frame joint may be arranged on the main frame section.

The first leveler frame joint may be arranged on the ground support frame.

The soil working tools may comprise, or consist of, at least one of harrow tines, cultivator tines, harrow discs.

The ground support may comprise, or consist of, at least one of a wheel and a roller.

The leveler tools may comprise, or consist of, at least one of a fixed leveler, such as a scraper, and a movable leveler, such as a leveler disc or a finger disc.

The setting device may be selected from a group consisting of a hydraulic actuator, an electric actuator, a pneumatic actuator and a manual setting device.

Hence, the setting device may be formed of a component having a variable length. A manual setting device may be any type of linear setting device which is capable of handling compressive forces along its linear extent, such as a threaded device which may be operated by means of a lever, a crank, or the like.

The agricultural implement may further comprise a depth actuator for setting a relative position between the main frame and the ground support frame.

According to a second aspect, there is provided a method of operating an agricultural implement for working soil. In the method, the agricultural implement comprises a main frame section, carrying a plurality of soil working tools, a ground support frame, carrying at least one rolling ground support, a leveler frame, carrying at least one levelling tool, configured for levelling soil that has been worked by the soil working tools and a setting device for setting a distance between the ground support frame and the leveler frame. The ground support frame is pivotably connected to the main frame by a ground support frame joint. The leveler frame is pivotable relative to the main frame by a first leveler frame joint. The setting device is pivotably connected to the leveler frame by a first setting device joint. The method comprises causing the ground support frame to pivot relative to the main frame section and causing a second setting device joint to be displaced relative to the ground support frame in a plane perpendicular to a pivot axis of the second setting device joint.

The ground support frame may be caused to pivot simultaneously with causing the second setting device joint to be displaced, in a synchronized manner.

The agricultural implement may further comprise a triangle link, pivotably connected to the ground support frame by a first triangle link joint, and a control link, pivotably connected to the main frame by a first control link joint and pivotably connected to the triangle link by a second control link joint. The setting device may be pivotably connected to the triangle link by the second setting device joint. The method may further comprise operating a depth actuator to cause the ground support frame to pivot relative to the main frame, such that the control link causes the triangle link to pivot relative to the ground support frame, such that the second setting device joint is displaced relative to the ground support frame.

### DRAWINGS

FIG. 1 schematically illustrates a top view of an agricultural implement.

FIG. 2 schematically illustrates a side view of the agricultural implement.

FIG. 3 schematically illustrates a detail view of a triangle link.

FIGS. 4a-4c schematically illustrate side views of the agricultural implement in different states of operation.

### DETAILED DESCRIPTION

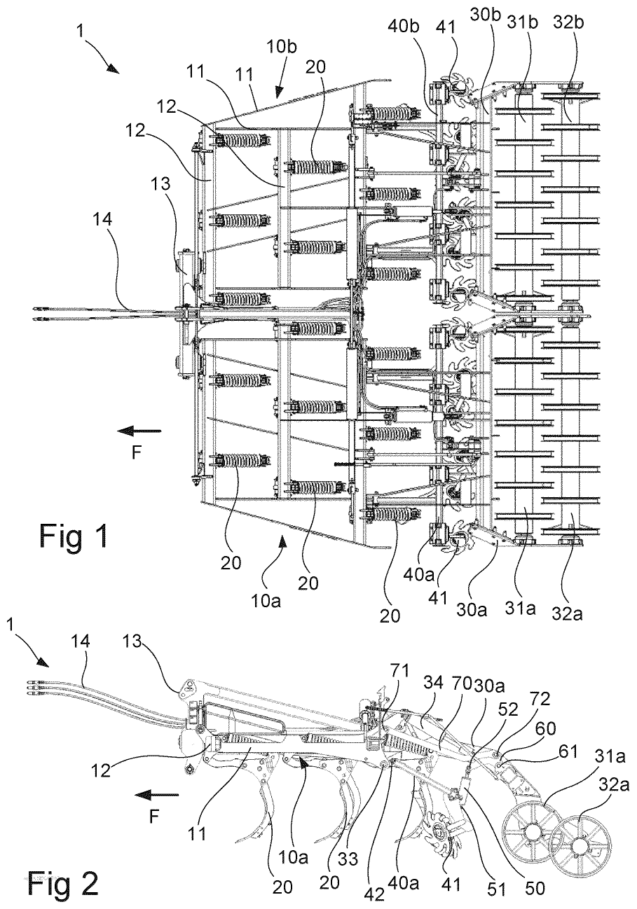

FIG. 1 schematically illustrates a top view of an agricultural implement 1 in the form of a cultivator.

In the following, an agricultural implement 1 for working soil will be described with reference to a cultivator having a pair of laterally aligned main frame sections 10a, 10b, which can be folded relative to each other about a horizontal axis that is parallel with an operating direction F of the agricultural implement 1.

A main frame section 10a, 10b may comprise one or more longitudinally extending members 11 and one or more transversely extending members 12.

It is understood that the agricultural implement may comprise one, two, three, four, five, or more, main frame sections that are laterally aligned and, where applicable, foldable such that the agricultural implement may be transformed between a working state, where all main frame sections are substantially horizontally oriented, and a transport state, wherein at least some of the main frame sections have been folded, e.g. to an approximately vertical orientation, so as to reduce, at least, the width of the agricultural implement, so as to allow for road transport.

The agricultural implement 1 is further illustrated as comprising a plurality of soil working tools 20, which here are illustrated as cultivator tines, and which are supported by the main frame sections 10a, 10b, and in particular by transversely extending members 12. Hence, the soil working tools 20 are distributed both longitudinally and horizontally over each main frame section 10a, 10b, so as to provide a desired tool spacing while avoiding blocking of the agricultural implement 1.

In the illustrated embodiment, the agricultural implement 1 is a partially carried configuration, in the sense that the agricultural implement 1 has a coupling 13 for attachment to a three-point hitch of a tractor (not shown). Hydraulic connectors 14 are also illustrated.

It is understood that the agricultural implement 1 may also be provided as a towed configuration, which may thus have a front ground support (not shown), such as one or more wheels.

The agricultural implement 1 further comprises a pair of ground support frames 30a, 30b, each carrying, at distal portions thereof, ground supports 31a, 32a; 31b, 32b, which here are illustrated in the form of rollers.

The rollers may be any type of roller, such as cage rollers, rubber rollers, soil rollers or steel rollers.

The ground support frames 30a, 30b are, at proximal portions thereof, pivotably connected to the main frame sections 10a, 10b by one or more ground support frame joints 33, such that the ground support frames 30a, 30b are pivotable relative to the main frames 10a, 10b. At least one depth actuator 34 is operable between each main frame section 10a, 10b and its associated ground support frame 30a, 30b.

Setting of an operating depth of the soil working tools 20 is thus achieved by operating the depth actuator(s) 34 to cause the ground support frame 30a, 30b to pivot relative the main frame section 10a, 10b, whereby the ground support is lowered relative to the main frame to reduce operating depth of the soil working tools 20, or raised relative to the main frame section 10a, 10b to increase operating depth of the soil working tools 20.

The agricultural implement further comprises a pair of leveler frames 40a, 40b, each of which carrying a plurality of levelling tools 41, which here are illustrated as finger discs. Other types of levelling tools, such as levelling discs or scrapers may also be used.

The leveler frames 40a, 40b are pivotably connected, at proximal portions thereof, to the main frame sections 10a, 10b, or, as illustrated here, to the ground support frames 30a, 30b, by one or more leveler frame joints 42, close to proximal portions of the ground support frames 30a, 30b.

Hence, the leveler frames 40a, 40b, and thus the levelling tools carried by the leveler frames, are pivotable relative to the main frame sections 10a, 10b, such that relative vertical positions between the soil working tools 20 and the levelling tools 41 can be adjusted.

A setting device 50 is connected generally between an intermediate portion of the ground support frames 30a, 30b and the respective leveler frame 40a, 40b, such that a position of the leveler frame 40a, 40b can follow a position of the ground support frame 30a, 30b.

For example, each leveler frame 40a, 40b may follow its associated ground support frame 30a, 30b.

The setting device 50 may be a linear actuator or a linearly adjustable device, which is configured to selectively set said distance between the leveler frame 40a, 40b and the ground support frame 30a, 30b.

Typically, the setting device would be operated, or adjusted, to set a desired distance between the leveler frame 40a, 40b and the ground support frame 30a, 30b.

The setting device 50 may be pivotably connected to the leveler frame 40a, 40b by a first setting device joint 51 and pivotably at the ground support frames 30a, 30b by a second setting device joint 52.

This second setting device joint 52 may be displaceably connected to the ground support frame 30a, 30b, such that the relative position of the second setting device joint 52 and the ground support frame 30a, 30b can be varied.

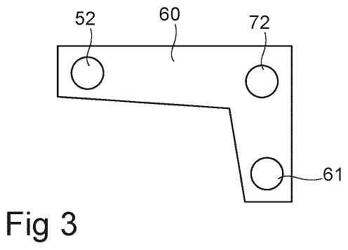

A non-limiting concept for providing such a displaceable arrangement of the second setting device joint 52 will be illustrated with reference to FIG. 3.

Referring to FIG. 3, a connection between the setting device 50 and the ground support frames 30a, 30b may be provided by a triangle link 60, i.e. a link having at least three mutually parallel pivot joints 52, 61, 72 which are spaced from each other and arranged at corners of a triangle, as seen in a plane perpendicular to pivot axes of the pivot joints. The pivot joints 52, 61, 72 may be mutually spaced from each other along the pivot axes.

Hence, the triangle link may be formed, as illustrated, in a generally L-shape, although other shapes can be provided so long as the pivot joints 52, 61, 72 are positioned at corners of a triangle.

The triangle link 60 may be pivotably connected to the ground support frame 30a, 30b by the triangle link joint 61.

The setting device 50 may be connected to the triangle link 60 by the second setting device joint 52.

A control link 70 may be pivotably connected to the main frame section 10a, 10b by a first control link joint 71, which is spaced from the ground support frame joint 33, and which is pivotably connected to the triangle link 60 by a second control link joint 72.

Hence, when the depth actuator 34 is operated to change the relative orientation of the main frame section 10a, 10b and the ground support frame 30a, 30b, by pivoting in a first direction about the ground support joint 33, the control link 70 will cause the triangle link 60 to pivot in an opposite direction about the triangle link joint 61. When the triangle link 60 is thus pivoted, the second setting device joint 52 is shifted, such that the distance between the ground support frame 30a, 30b and the leveler frame 40a, 40b is altered.

In the illustrated embodiment, a clockwise pivoting of the ground support frame 30a, 30b about the ground support frame joint 33 will cause a counter-clockwise pivoting of the triangle link 60, such that the second setting device joint 52 is shifted downwardly, thereby increasing the distance between the ground support frame 30a, 30b and the leveler frame 40a, 40b.

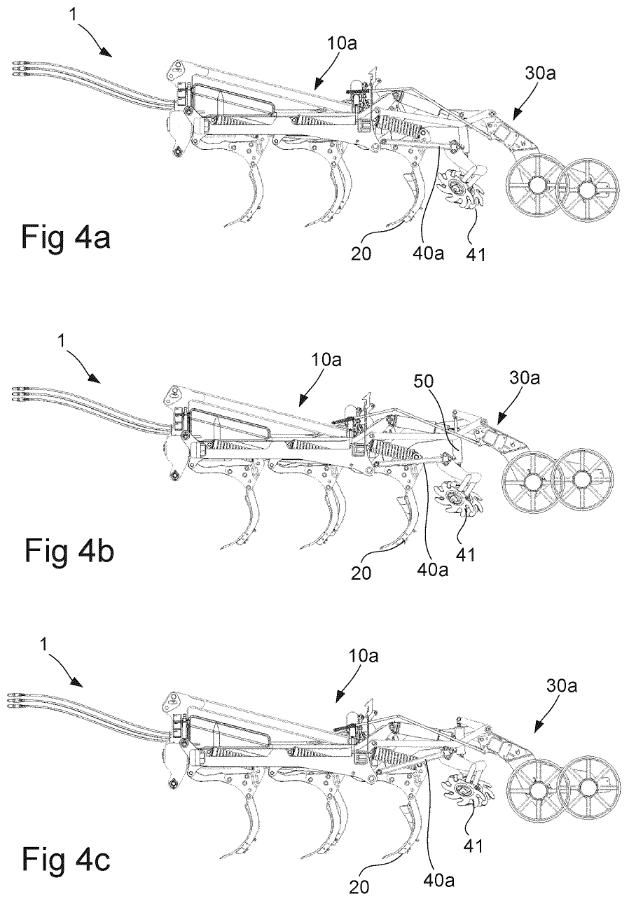

While FIG. 2 illustrates the agricultural implement 1 in a lifted state, such as would be the case when turning on a headland, FIGS. 4a-4c schematically illustrate the agricultural implement in three different operating states.

FIG. 4a illustrates the agricultural implement 1 in a shallow operating state, as determined by the relative positions of the main frame sections 10a, 10b and the ground support frame 30a, 30b.

FIG. 4b illustrates the agricultural implement 1 in a deep operating state, as determined by the relative positions of the main frame sections 10a, 10b and the ground support frame 30a, 30b. In FIG. 4b, the levelling tools 41 are in a lower, more aggressive position, as determined by the setting device 50, which is here in a fully extended state.

FIG. 4c illustrates the agricultural implement 1 in a deep operating state as determined by the relative positions of the main frame sections 10a, 10b and the ground support frame 30a, 30b. In FIG. 4c, however, the levelling tools 41 are in an upper, less aggressive position, as determined by the setting device 50, which is here in a fully retracted state.

Hence, the setting device 50 allows for setting a level of aggressiveness of the levelling tools 41.

The arrangement of the triangle link 60 and the control link 70 allows for the movement of the second setting device joint 52, such that the levelling tools will follow the ground supports 31a, 32a; 31b, 32b.

It is understood that the second setting device joint 52 may be caused to move in other ways than through the control link 70, such as by assigning a separate actuator to cause the motion.

As an alternative, the setting device may be formed by a set of at least two links of varying fixed lengths, whereby one of the fixed links is selected in order to provide a predetermined distance between the leveler frame 40a, 40b and the ground support frame 30a, 30b, and wherein the links may be exchanged for links of a different length in the event it is desired to alter the distance.

As yet another alternative, the setting device may be formed by an elongate member having a plurality of spaced apart connectors, such as holes or recesses, one of which may be engaged by a fastener, such as a pin or a bolt, which attaches the setting device 50 to, e.g. the triangle link 60 at the second setting device joint 52, to provide a desired effective length of the setting device 50. The soil working tools 20 may be cultivator tines, harrow tines or any other type of soil working tool for which it may be desirable to operate at varying depths and which are used in conjunction with levelling tools that are arranged behind, with respect to the working direction F, the soil working tools.

1-13. (canceled)

14. An agricultural implement in the form of a harrow or a cultivator for working soil, comprising:
a main frame section, carrying a plurality of soil working tools,
a ground support frame, carrying at least one rolling ground support,
a leveler frame, carrying at least one levelling tool, configured for levelling soil that has been worked by the soil working tools, and
a setting device for setting a distance between the ground support frame and the leveler frame,
wherein the ground support frame is pivotably connected to the main frame by a ground support frame joint, and
wherein the leveler frame is pivotable relative to the main frame by a first leveler frame joint,
characterized in that
the setting device is pivotably connected to the leveler frame by a first setting device joint, and by a second setting device joint is displaceably connected relative to the ground support frame,
such that the second setting device joint is displaceable relative to the ground support frame in a plane that is perpendicular to a pivot axis of the second setting device joint.

15. The agricultural implement as claimed in claim 14, further comprising:
a triangle link, pivotably connected to the ground support frame by a triangle link joint, and
a control link, pivotably connected to the main frame section by a first control link joint and pivotably connected to the triangle link by a second control link joint,
wherein the setting device is pivotably connected to the triangle link by the second setting device joint,
such that pivoting of the ground support frame relative to the main frame section causes the control link to bring the triangle link to pivot relative to the ground support frame, whereby the second setting device joint is displaced relative to the ground support frame.

16. The agricultural implement as claimed in claim 15, wherein the first setting device joint, the first control link joint, the second control link joint and the first triangle link joint are configured such that rotation of the ground support frame in a first direction about the ground support frame joint causes the triangle link to rotate in a second direction, opposite the first direction, about the first triangle link joint.

17. The agricultural implement as claimed in claim 14, wherein the first leveler frame joint is arranged on main frame section.

18. The agricultural implement as claimed in claim 14, wherein the first leveler frame joint is arranged on the ground support frame.

19. The agricultural implement as claimed in claim 14, wherein the soil working tools comprise at least one of harrow tines, cultivator tines, harrow discs.

20. The agricultural implement as claimed in claim 14, wherein the ground support comprises at least one of a wheel and a roller.

21. The agricultural implement as claimed in claim 14, wherein the leveler tools comprise at least one of a fixed leveler, such as a scraper, and a movable leveler, such as a leveler disc or a finger disc.

22. The agricultural implement as claimed in claim 14, wherein the setting device is selected from a group consisting of a hydraulic actuator, an electric actuator, a pneumatic actuator and a manual setting device.

23. The agricultural implement as claimed in claim 14, further comprising a depth actuator for setting a relative position between the main frame section and the ground support frame.

24. A method of operating an agricultural implement for working soil, in the form of a harrow or a cultivator, the agricultural implement comprising:
a main frame section, carrying a plurality of soil working tools,
a ground support frame, carrying at least one rolling ground support, a leveler frame, carrying at least one levelling tool, configured for levelling soil that has been worked by the soil working tools, and
a setting device for setting a distance between the ground support frame and the leveler frame,
wherein the ground support frame is pivotably connected to the main frame by a ground support frame joint,
wherein the leveler frame is pivotable relative to the main frame by a first leveler frame joint, and
wherein the setting device is pivotably connected to the leveler frame by a first setting device joint,
wherein the method comprises:
causing the ground support frame to pivot relative to the main frame section and
causing a second setting device joint to be displaced relative to the ground support frame in a plane perpendicular to a pivot axis of the second setting device joint.

25. The method as claimed in claim 24, wherein the ground support frame is caused to pivot simultaneously with causing the second setting device joint to be displaced.

26. The method as claimed in claim 24, wherein the agricultural implement further comprises:
a triangle link, pivotably connected to the ground support frame by a first triangle link joint, and
a control link, pivotably connected to the main frame by a first control link joint and pivotably connected to the triangle link by a second control link joint,
wherein the setting device is pivotably connected to the triangle link by the second setting device joint,
the method further comprising:
operating a depth actuator to cause the ground support frame to pivot relative to the main frame, such that the control link causes the triangle link to pivot relative to the ground support frame, such that the second setting device joint is displaced relative to the ground support frame.
